(19) United States
(12) Patent Application Publication
(10) Pub. No.: US 2013/0204580 A1
(43) Pub. Date: Aug. 8, 2013

(54) Hardware Data Processing Unit and Method for Monitoring a Cycle Duration of a Routing Unit

(71) Applicants: Eberhard Boehl, Reutlingen (DE); Ruben Bartholomae, Reutlingen (DE)

(72) Inventors: Eberhard Boehl, Reutlingen (DE); Ruben Bartholomae, Reutlingen (DE)

(73) Assignee: ROBERT BOSCH GMBH, Stuttgart (DE)

(21) Appl. No.: 13/638,091

(22) PCT Filed: Mar. 16, 2011
(86) PCT No.: PCT/EP11/53952

§ 371 Date: Dec. 17, 2012

(30) Foreign Application Priority Data
Mar. 31, 2010 (DE) 10 2010 003 530.0

(51) Int. Cl. G06F 11/30

(52) U.S. Cl. CPC G06F 11/3089
USPC 702/186

(57) ABSTRACT

A hardware data processing unit has at least one base transmitter module, at least one logic unit, and at least one routing unit. The base transmitter module provides base values of a physical variable. The routing unit arbitrates a group of data nodes associated therewith in a determined sequence. The duration of a cycle is defined by a complete iteration of the determined sequence. The hardware data processing unit has a mechanism that checks the cycle duration. The mechanism carries out a first blocked access to a determined data node of the group to capture and store a first base value from the base transmitter module. The mechanism carries out a second blocked access to the determined data node to capture and store a second base value. The mechanism determines a difference between the first and the second base values.

### PRIOR ART

The present invention relates to a hardware data processing unit and to a method for monitoring a cycle duration for a routing unit.

It is customary for internal timings in hardware data processing units to be monitored by an external processor or by an external watchdog with its own time base. Such monitoring approaches are used for controllers in the automotive sector, for example, particularly when the timings have related safety-critical control processes, for example in the engine control. This thus either requires the provision of a processor computation resource associated with a hardware data processing unit and time for this task, or it is necessary to provide the additional hardware and software for an external watchdog monitor.

### DISCLOSURE OF THE INVENTION

### Advantages of the Invention

The present invention as per the independent claims allows a particularly efficient, safe and reliable check on the cycle time of a routing unit in a hardware data processing system by virtue of the monitoring being performed by means in the hardware data processing unit. The routing unit successively arbitrates all the data nodes in a group of data nodes which is associated therewith. A pass through this order (from a particular position in the order until this position is reached again) defines the cycle time that is to be checked. Repeated obstructive access operations to a data node by a logic module in the hardware data processing unit, which logic module itself belongs to the group of data nodes, allows the cycle duration to be ascertained from these base values by virtue of the success of the access operations triggering the transmission and storage of base values from a base transmitter module.

Further advantages and improvements arise from the features of the dependent claims.

It is particularly advantageous if the data nodes successively arbitrated by the routing unit are either (all) data sinks associated with the routing unit or (all) data sources associated with the routing unit, since this allows particularly comprehensible and meaningful monitoring of the cycle time, and the access operations by the logic unit can be designed as exclusively read processes or exclusively write processes.

It is particularly expedient for the base provided to be time and for the base values provided to be time stamps. In the automotive sector, for example, the base “angle” (angle stamp base values) is alternatively or additionally also important. Depending on the application, it is also possible to use physical variables or bases other than these.

In one advantageous refinement, the ascertained cycle duration or the difference in the base values is compared with comparison values or with at least one comparison value, for example with a minimum, a maximum, a value that is to be satisfied precisely, a range or else the comparison greater than zero. Hence, depending on the requirements of the cycle duration, it is possible to check or monitor various constraints and furthermore also the activity of particular modules and signals involved in the comparison. In order to check the activity of the modules and signals involved in the comparison particularly efficiently, provision may furthermore be made for a comparison, preferably every comparison, regardless of whether it is successful or unsuccessful, to involve the generation of an activity signal, for example as a CPU interrupt or else as a signal to the outside or to another module.

If at least one comparison is unsuccessful, this information can be used for subsequent measures such as error signal generation or CPU interrupts, so that the recognized error can quickly result in the activation of error handling routines, for example.

### DRAWINGS

In the drawings,

FIG. 1 shows a schematic architecture of a timer module,

FIG. 2 shows a schematic architecture of a logic module in a timer module, and

FIG. 3 shows a method for checking a cycle duration for a routing unit.

A timer module in a controller can preferably be implemented as an IP block in the microcontroller of a controller, for example a vehicle controller. This block combines the time functions and possibly angle functions, receives signals from the sensor system in the vehicle (e.g. rotation rate sensor in an ESP), and evaluates said signals and acts on the actuators in the automobile (e.g. on the driving dynamics in the case of “skidding”). Such a timer, as described below, can alternatively also be integrated into an output stage or provided separately, but it always requires a configuring unit (e.g. external computation unit); when it is integrated in the controller microcontroller, this is the or a controller CPU (or computation unit), for example.

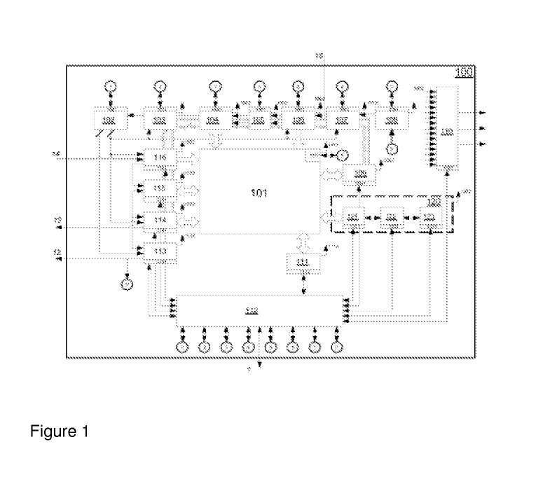

FIG. 1 shows the overall architecture of an exemplary timer module 100. In simplified form, the overall structure of the timer module has a signal input unit(s) 116 which outputs values to a routing unit 101, these values are processed in other modules and the processed values are forwarded via the routing unit 101 to the output unit 114. The parallel manner of operation of the modules described below allows a large number of requests to be handled within a short time. Provided that particular modules are not required, they can also be switched off for the purpose of saving power (power consumption, temperature reduction).

The essence of the timer module 100 is the central routing unit 101, to which input (e.g. module(s) 116), output (e.g. module(s) 114), processing (e.g. module 109) and memory units (e.g. module 120) are connected.

The routing unit 101 connects the modules flexibly and configurably to one another and, by virtue of the obstructive requesting and transmission of data, presents a new interrupt concept for a timer module. It does not require the implementation of an interrupt controller, which saves surface area and hence chip costs. A central concept of the timer unit 100 is the routing mechanism of the routing unit 101 for data streams. Each module (or submodule) of the timer module 100, which is connected to the routing unit 101, may have any number of routing unit write channels (data sources) and any number of routing unit read channels (data sinks). The design of the routing unit 101 provides for any data source to be connected flexibly and efficiently to any data sink. This can be implemented by means of the data routing mechanism, which is known from DE 10200900189, which has not been published previously.

The parameter memory module 120 comprises three subunits 121, 122 and 123. The subunit 121 is the interface between the FIFO (First In, First Out) memory 122 and routing unit 101. The subunit 123 is the data interface between the generic bus interfaces of the modules, or the multiplex apparatus 112 (see below), and the FIFO 122. The parameter memory module 120 can be used as a data memory for incoming data characteristics or as a parameter memory for outgoing data. The data are stored in a memory, for example a RAM, which is logically situated within the FIFO subunit 122.

The timer input module 116 (preferably comprising a plurality of inputs) is responsible for filtering and picking up input signals for the timer module 100. Various characteristics of the input signals can be measured within the channels of the timer input module 116. This involves the timer input module 116 logically combining the signals with time information and other physical information and using them, following processing and possibly buffer-storage in the output unit 114, for the generation of output signals. By way of example, the physical information is the angle of an engine or else any other physical variable, such as mass, temperature, level of a liquid, phase of an oscillation, a number of events (edges) or the period duration of a signal. Input characteristics may comprise time stamp values from detected rising or falling input edges together with the new signal level or the number of edges since a channel was enabled together with the current time stamp or PWM signal lengths for an entire PWM period, for example. The values which are assigned to an input signal, such as the value of the time base and the value of the angle base at the time of the input event, thus characterize the input signal and permit calculations in further modules which are connected to the routing unit 101 (e.g. module 109), and can then address an output unit (output unit 114) in which the transmitted values in conjunction with the current time and/or angle base values are taken as a basis for producing output signals.

For advanced data processing, the detected input characteristics of the timer input module 116 can be routed by the routing unit 101 to further processing units of the timer module 100.

The unit for clock conditioning 102 is responsible for the clock generation of the counters and of the timer module 100. It provides configurable clock cycles, and the time base unit 103 with both time-related and position-related counters provides a common time base for the timer module 100 or provides current time and position information (e.g. angles).

The individual modules are supplied with the clock cycles and time bases and interchange data with one another via the routing unit 101. Comparators which are present locally in the individual modules compare the data with the current time and/or position and signal decisions made in the process, such as the connection of an output signal.

The routing of the data by means of the routing unit 101 involves the branch unit 111 also making the data from a source available to a plurality of data sinks being a or different module(s), since there is usually provision for obstructive reading of the data, which allows a data item to be read from a source only once. Since each write address for the submodule channels of the timer module 100 which are able to write to the routing unit 101 can be read only by a single module, it is impossible to make a data stream available to different modules in parallel. This does not apply to sources which do not make their data invalid after the data have been read by a receiver, as may be provided for the DPLL module 104, for example. In order to solve this problem for regular modules, the branch unit 111 allows data streams to be duplicated a plurality of times. This submodule 111 provides input and output channels. In order to clone an incoming data stream, the relevant input channel can be mapped on to one or more output channels.

The DPLL (digital phase locked loop) module 104 is used for frequency multiplication. The purpose of this module 104 is to achieve greater accuracy for the position or value information even in the case of applications with rapidly changing input frequencies. The DPLL module 104 takes position-related input signals and produces pulses which allow more finely divided position information in the time base unit 103. Hence, by way of example, an angle clock can display a finer resolution for an angle of rotation than the input signals prescribed. Furthermore, the DPLL module 104 has information available about speed or rotation speed, and predictions can be made regarding when a prescribed position will have been reached, even with the inclusion of a lead time (e.g. allowance for the inertia of the actuation module). The input signals for the DPLL module 104 are routed via the timer input module 106, are filtered in an input mapping module 105 or else are combined in a sensor pattern evaluation module 115, for example particularly for the evaluation of electric motors.

In comparison with the other timer input modules 116, the timer input module 106 thus has the special feature that it forwards current filter values, which are used to filter input signals, to the input mapping module 105 and the DPLL module 104, where the filter values are taken into account in the time stamps of the filtered edge in order to obtain an actual edge time.

The sensor pattern evaluation module 115 can be used in order to evaluate the inputs of a plurality of Hall sensors and in order to assist the operation of DC machines (BLDC, brushless direct current) together with the timer output module 113 (preferably comprising a plurality of outputs). In addition, the sensor pattern evaluation module 115 can also be used in order to calculate the rotation speed of one or two electrical machines, for example.

The output comparison unit 108 can be used to compare output signals with one another on a bit-by-bit basis. It is designed for use in safety-related applications. The principal idea in this context is to have the opportunity to double outputs in order to allow comparison in this unit. If a simple EXOR (exclusive OR) function is used for this purpose, for example, it may be necessary to safeguard the output response of a complete cycle of the output modules that are to be compared. As FIG. 1 shows, the output comparison unit 108 is connected to the connection between the timer output module 113 and the pin 12 by means of the connection denoted by the reference symbol 9.

The monitor unit 107 is likewise designed for use in safety-related applications. In this case, the principal idea is to provide the opportunity to monitor jointly used circuits and resources. Thus, the activity of the clocks and the basic activity of the routing unit 101 are monitored. The monitor unit 107 allows an external CPU (central processing unit) or generally an external computation unit to easily monitor central signals for safety-critical applications.

Interrupt lines (interrupt request lines) for the modules are denoted in FIG. 1 by four-digit reference symbols with the ending “2” and the first three digits corresponding to the module. The interrupt concentration module 110 is used in order to bunch the interrupt lines XXX2 of the individual submodules in suitable fashion into interrupt groups and then to forward them to the external computation unit.

All modules can be configured by the computation unit via a bus interface (universal handshaking interface). This bus interface can also be used to interchange data. For the output module that is not connected to the routing unit, the timer output module 113, this means that the outputs are configured for periodic procedures, for example. The timer output module 113 provides independent channels, e.g. in order to generate PWM (pulse width modulated) signals at each output pin. In addition, a pulse counter modulator signal can be produced at an output of the timer output module 113.

The timer output module 114 connected to the router unit 101 is capable of producing complex output signals without CPU interaction on account of it being connected to the router unit 101. Typically, output signal characteristics are made available via the connection to the router unit 101 by submodules connected to the router unit 101, such as the DPLL submodule 104, the multichannel sequencer module 109 or the parameter memory module 120.

The multichannel sequencer module 109 is a generic data processing module which is connected to the routing unit 101. One of the main applications of said multichannel sequencer module is to calculate complex output sequences which may be dependent on the time base values of the time base unit 103 and which are handled in combination with the module 114. Each submodule of the timer output module 114 connected to the router unit 101 comprises output channels which can operate independently of one another in various configurable modes of operation.

The microcontroller bus is denoted by the reference symbol 11 in FIG. 1, and various pins (or groups of pins) are denoted by the reference symbols 12-15.

The timer module is equipped with a generic bus interface which can be customized in versatile fashion for various SoC buses (SoC=system on a chip). The customization of the generic bus interface is typically achieved by means of a bridge module which translates the signals from the generic bus interface into the signals of the respective SoC bus. The generic bus interfaces of the modules are denoted in FIG. 1 by four-digit reference symbols with the ending “1” and the first three digits corresponding to the module. The multiplex apparatus 112 multiplexes the generic bus interfaces. In FIG. 1, the connections between the generic bus interfaces XXX1 and the multiplex apparatus 112 are denoted by the reference symbols 1-8.

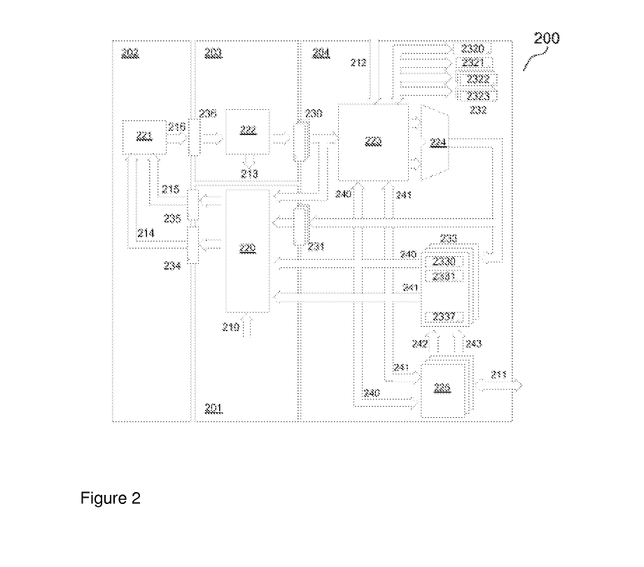

FIG. 2 shows the multichannel sequencer module 109 from FIG. 1 in an advantageous embodiment 200. In this case, the multichannel sequencer module (MCS) 200 has the stages RAM access decoding 201, RAM access 202, command predecoding 203 and command execution 204. The RAM access decoding stage 201 comprises the RAM access coder 220, the RAM access stage 202 comprises the RAM memory 221, the command precoding stage 203 comprises the command predecoder 222, and the command execution stage 204 comprises the command decoder 223, the arithmetically logic unit (ALU) 224 and also the router unit interface 225.

The RAM access decoder 220 comprises an input 210 for data or address information from the external computation unit, and also further inputs from the command execution stage 204 and also outputs to the RAM access stage 202. The stages 201 and 202 have the registers 234 and 235 arranged between them.

The register 234 is connected to an input of the RAM 221 by means of the RAM data input connection 214, and the register 235 is connected to a further input of the RAM 221 by means of the RAM address connection 215. The RAM 221 is connected by means of the RAM data output connection 216 to the register 236, which is arranged between the stages 202 and 203.

The register 236 is connected to an input of the command predecoder 222. Furthermore, the command predecoder 222 has a data output connection 213 in the direction of the external computation unit and has a connection to the register 230, which is arranged between the stages 203 and 204.

The register 230 is connected to an input of the command decoder 223 and to an input of the RAM access decoder 220. An input of the command decoder 223 is connected to a connection 212 from the time base unit 103 from FIG. 1. Similarly, the command decoder 223 is connected to the register block 232, or the individual registers 2320, 2321, 2322 and 2323 thereof. Two outputs of the command decoder 223 are connected to two inputs of the ALU 224. Similarly, the command decoder 223 is connected to the RAM access decoder 220, the router unit interface 225 and the register block 233, respectively, by means of the connections 240 and 241. The register block 233 comprises the registers 2330, 2331, . . . , 2337. The ALU 224 is connected both to the register 231 and to the register block 233 by means of one connection. The register 231 is arranged between the stage 204 and the stage 201 and is in turn connected to the RAM access decoder 220. The router unit interface 225 is connected to the register block 233 by means of connections 242 and 243. Furthermore, the router unit interface 225 has a connection 211 to the router unit 101 from FIG. 1.

The modules which are served in an HW data processing unit (HW-DP unit), e.g. timer module 100 shown in FIG. 1, by means of a routing unit, preferably routing unit 101 shown in FIG. 1, may require timings, or cycle duration, defined in even more detail below, for the routing unit to be monitored. In the timer module 100 shown in FIG. 1, the monitoring of the cycle duration for the routing unit 101 is particularly important because in the event of failure of the routing unit 101 it is no longer possible for the connected modules to be supplied with data. This is particularly important with a view to safety requirements, because monitoring operations for signal profiles of output signals to the actuator system that is to be controlled by the controller in which the timer module 100 is preferably integrated may also take place with a delay or modules may not be able to be activated at all. Thus, a constant cycle duration may sometimes be demanded in order to be easily able to ascertain the slowest routing duration (worst case). In order to check this circulation time, it is possible to use a dedicated, programmable logic module of the HW-DP unit, or of the timer 100, such as the multichannel sequencer module 109 (FIG. 1), or 200 (FIG. 2). This eliminates the need for constant checking by the external CPU, which relieves the load on the latter, and it is also possible to dispense with an external watchdog for this purpose.

Even for non-safety-critical applications, a constant ARU cycle time may be important because the routing of the data means a delay in a procedure. If the cycle time is not constant, this means that the subsequent processes are at one point handled sooner or later. This jitter in the execution is sometimes undesirable when one wishes to allow for the delay values in the control of procedures. With a constant cycle time, it may be possible to allow for the delay as a constant offset.

A particularly advantageous routing method for the routing unit 101 is described in DE 10200900189, which has not been published previously. In one preferred refinement, the basic principle in this case is that the routing unit arbitrates all data sources associated therewith sequentially, or successively in a stipulated order, and forwards the data which are present in the data sources to the relevant data sinks. The method described therein is described in more detail below with reference to two exemplary embodiments; for further details of the implementation, reference is made to DE 10200900189.

In this case, the terms data source, data sink and data node are used here to mean the following: a data source is a data node which provides data, and a data sink is a data node which receives data. It is pointed out that a functional unit which is fitted in a package or a chip, for example, can act both as a data source and as a data sink, and it can also do so repeatedly. This unit can then be considered to be split into the relevant number of data sinks and data sources for the inventive data interchange between data sources and data sinks.

The circuit arrangement according to the invention generally comprises n+m data nodes (number of data sources n>0, number of data sinks m>0). In addition, in this exemplary embodiment, the circuit arrangement includes an arbitration unit, for example a modulo-n counter as a selection unit for the arbitration. A decoder, for example a 1-out-of-n decoder, is used to select precisely one data source from the data sources n with every state of the counter. All data sources are successively arbitrated/selected in a stipulated order, regardless of whether the respective source has a data item and an associated write request (or request signal), which is conditional upon the validity information explained above. The respectively selected data source transmits the provided data to all data sinks, for example together with a validity signal, via a communication line and additionally transmits an address via the communication line to a one-out-of-m decoder. The data sink which is thus selected is provided with a selection signal formed from the address. A ready signal (read request) which is present on the data sink indicates whether the data sink is ready to receive new data. The validity information in the concomitantly transmitted validity signal and the readiness of the sink to accept the data are used to generate a write signal. This write signal is used to transfer the data to the memory, and at the same time the read request signal from the selected data sink is reset. At the same time, the write signal is the acknowledgement signal for successful transmission and is returned from the selected data sink to the selected data source so as to influence the validity information therein, specifically so as to mark the data item as read and hence to reset the write request.

In particular refinements of arbitration of the sources, it is possible to delay the signals by means of pipeline stages or other delay mechanisms. It is also possible to transmit a data item to a plurality of the data sinks. In addition to checking all sources in succession in a fixed order, it may also be possible to repeatedly poll particular sources in one pass of the router unit by configuring the arbitration.

Similarly, the routing method according to a second exemplary embodiment in DE 10200900189 can also be performed by successively arbitrating or selecting all data sinks, as described by way of example below. In this case, a modulo-m counter is then used as a selection unit for the arbitration. A counter increments exemplary embodiment at a prescribable clock rate the value of the counter up to m-1 and then starts at 0 again. The 1-out-of-m decoder is used to select precisely one data sink from the data sinks with every state of the counter. This selected data sink provides an address and a read request signal for a multiplexer, which forwards the data from the selected block to the selected data sink together with the address and the read request signal via a communication link. A 1-out-of-n decoder takes the address and selects precisely one data source from the data sources and makes the read request with the data ready signal available to said data source. The read request and the data ready signal are used to form a validity signal which denotes valid data precisely when both the read request and the data ready signal are active. This selected data source outputs the requested data to the multiplexer, and the latter ensures that precisely the data from the selected data source together with the validity information (acknowledgement signal) are forwarded to all data sinks via the communication link. The selected data sink stores the valid data.

For such sequential routing designs, which thus involve all data sources (and all data sinks) associated with a routing unit being polled successively in a stipulated or else flexibly stipulatable order, the approach described below can be used to monitor the cycle duration of the routing unit—that is to say the duration until all data sources (and all data sinks) have been polled at least once, to be more precise until the arbitration cycle, that is to say the stipulated order (in the above examples of the counters), starts over again. More generally, the routing duration is the period from a particular point in the arbitration order before this point in the arbitration order is reached again the next time. In this case, the cycle duration may be a period of time, but may also be an angle duration or generally the cycle duration relative to a physical variable (in the cited examples time and angle). The base values in this case denote values which indicate the value of the base at a particular time and are provided by a base unit, for example the module 103 in FIG. 1, for example time or angle stamps.

By way of example, the following two alternative demands can be made on the routing unit 101 for the purpose of monitoring the cycle duration thereof:

a) The cycle duration of the routing unit 101 must be (largely) constant (for example situated in a stipulated range) in order to make it a simple matter to ascertain the longest permitted routing duration (worst case).

b) The cycle duration must be precisely constant in order to avoid a variable delay in the subsequent processes.

c) The cycle duration of the routing unit 101 must not exceed a prescribed value, in order to be able to react to events in good time.

What may be used in the context is a logic module, for example the multichannel sequencer 109 (FIG. 1) or 200 (FIG. 2). In this case, the multichannel sequencer 109 is a logic unit (with logic subunits such as arithmetic logic unit (ALU) 224 or (pre)decoder 220, 222, 223) which can be programmed by means of its registers (e.g. by the external CPU, or computation unit) and which can also perform computational operations and comparison operations. In the top image of the data nodes associated with the routing unit 101, the multichannel sequencer 109 is preferably itself at least one data sink and at least one data source.

The text below describes an exemplary embodiment which can be used in the case of sequential arbitration of data sinks for checking the cycle duration of the routing unit 101 for the base “time”. The base transmitter module in the hardware data processing unit is therefore a time base transmitter. To this end, the multichannel sequencer module 109 or 200 contains a program loop which has the following procedure, for example:

1. Obstructive reading by the multichannel sequencer module 109 or 200 as a data sink for a stipulated channel (a stipulated data sink if the multichannel sequencer 109 or 200 represents a plurality of data sinks) from a fixed address (data source) of the routing unit 101, which constantly provides a data item for reading. In this context, obstructive reading is understood to mean that the multichannel sequencer module 109 or 200 makes a read request—in this case to a fixed address of the routing unit 101, which is configured such that there is always a valid data item available. By way of example, the fixed address may be a data source such as the input module 116. The value of the data item itself is of no significance to the approach. This read request is considered cyclically by the routing unit 101. The sequential arbitration of the sinks to which the multichannel sequencer 109 or 200 belongs on the basis of a prescribed/prescribable border polls the read request in each cycle and, since there is always a valid data item available at the chosen address, meets it. The program execution of the multichannel sequencer module 109 or 200 is then continued.

2. Fetching of a first time base value (a first time stamp) by the multichannel sequencer module 109 or 200 from the time base unit 103 and storage in a first register of the multichannel sequencer module 109 or 200, e.g. in a first register of the register block 233. This step is triggered by the successful reading in step 1.

3. Renewed obstructive reading for the same channel (the same multichannel sequencer sink) at the stipulated address (source) of the routing unit 101 by the multichannel sequencer module 109 or 200 (in similar fashion to step 1). This reading cannot be performed until the routing unit handles this channel the next time, i.e. precisely one cycle time later than in step 1.

4. Fetching of a second time base value (a second time stamp) by the multichannel sequencer module 109 or 200 from the time base unit 103 and storage in a second register of the multichannel sequencer module 109 or 200, e.g. in a second register of the register block 233. This step is triggered by the successful reading in step 3.

5. Formation of the difference from the values in the second and first registers, e.g.: by the ALU 224 and storage in a third register, e.g. in a third register of the register block 233.

6. If appropriate, at least one comparison of the difference value with comparison values. By way of example, a check to determine whether the difference in the time base values in the third register is >0 or is greater than a minimum value, or whether the difference is below a prescribed limit.

7. Possible consequences. By way of example, an error can be signalled in the event of an unsuccessful comparison. By way of example, the error is signalled by means of a special error signal, e.g. to a further module (particularly the monitor unit 107) and/or by an error signal to the outside (i.e. to outside the timer module) and/or by initiating an interrupt to the external computation unit. The possible error signal lines or interrupt lines of the multichannel sequencer module 200 are not shown in FIG. 2, but could come from the ALU 224 which performs the comparisons, for example. The error signals or interrupts can subsequently trigger error handling or correction routines or, for example, can prompt the changeover of a controller to which the timer module belongs to a safety mode. These different, possible error signal mechanisms thus also apply to the other exemplary embodiments.

Since, following the reading in step 1, the reading in step 3 from the same address cannot be handled until the routing unit 101 has handled all additional requests which have been received (or has arbitrated or selected the other sinks in the stipulated order), a cycle duration of the routing unit 101 elapses between the retrieval operations for the time base values in steps 2 and 4. The difference in the third register is hence this cycle duration, in this case cycle time, of the routing unit 101.

In addition to a pure check on the cycle duration, the >0 checking in step 6 establishes, by way of example, whether the time base is actually active. In the case of an inactive time base, the time stamps would correspond to one another and the difference between them would be 0. It is therefore also a simple matter to check the activity of the time base in this case at the same time. This check can be dispensed with when checking for a minimum threshold (or coincides with the latter check). In step 6, a check is preferably performed to determine whether the cycle has taken too long. Naturally, depending on the application, it is also possible to check whether it has taken too short a time or whether it is in a desired range or corresponds precisely to a desired value.

If one of the comparisons fails, an error can be reported and, by way of example, an interrupt can be initiated to the external processor (external computation unit). The error signal can likewise be sent to the monitoring unit or monitor unit 107, can be stored thereon and can then be checked (regularly or irregularly) thereon by the computation unit.

It is possible to add or subtract additional (permitted or permissible) tolerances for the cycle durations to or from the difference value, or to make allowance for the tolerances when stipulating the comparison values.

For reliable monitoring for signal profiles, it is generally important in this context for jointly used signals, e.g. the clock or time information from the modules 102 and 103, to be monitored to determine whether they are still active, for example, and have not failed (e.g. time base at a standstill), since the inactivity of these jointly used signals would corrupt the result of the signal checks described. For this purpose, it is possible to use the activity comparison (>0) described above. In a further preferred refinement, it is furthermore possible to initiate an interrupt to the external computation unit and/or to send a signal to the monitor unit 107 for storage in step 6, regardless of the success of the comparison, that is to say particularly also in the event of a successful comparison. The computation unit receives this interrupt (if enabled/desired by computation unit, e.g. not in the case of excessive interrupt load) or polls the monitor unit 107, and thereby learns that a comparison has taken place. This means that the computation unit is implicitly able to establish the operability of the routing unit 101 and the activity of the clock cycles used. This refinement of the invention also involves the computation unit in the checking of the cycle duration of the routing unit 101. The computation unit has its own time base, which is usually monitored by an additional watchdog, that is to say that the computation unit remains capable of acting even in the event of an erroneous time base in the timer module.

In further refinements of the invention, it is also possible to check additional bases of other physical variables (such as angle values). As described for FIG. 1, the module 103 provides not only time base values but also angle base values, for example. To this end, the multichannel sequencer may contain additional registers which are used to store these values, and the difference formation is then also (or only) performed for these values. In that case, it is also again possible, in particular, to check a minimum value (e.g. >0) for this additional difference in order to check the activity of the base transmitters. Again, as above, it is naturally possible for different comparisons to take place (minimum value, maximum value, range . . . see above). If the signal profile to be expected does not rise or fall monotonously (for the time base, a monotonously rising profile applies), at least one expected signal activity can be checked (e.g. angle profile in the case of reverse running).

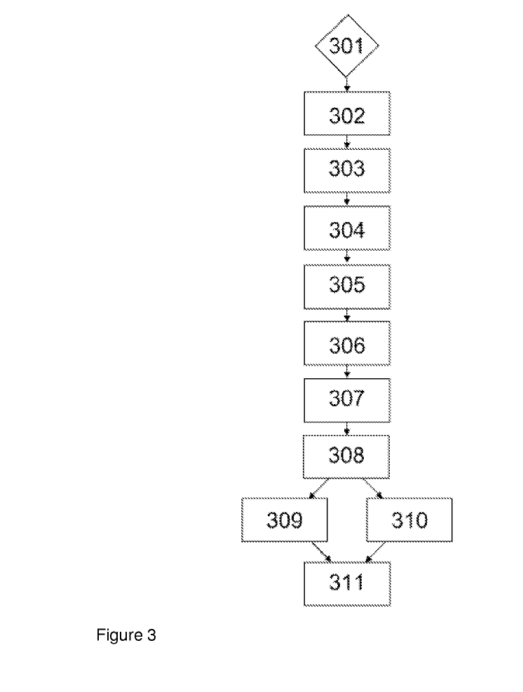

FIG. 3 shows an exemplary method for the checking of a routing cycle duration for a routing unit in a hardware data processing unit by a logic module in the hardware data processing unit.

In a first step 301, the logic module as a data sink reads a stipulated address (data source) for the routing unit by means of obstructive reading. In this case, the stipulated address and the routing unit have been configured in advance such that a data item is constantly held ready at this stipulated address for reading.

In the second step 302, the logic module fetches a base value, associated with the reading time of the data item from the stipulated address, from a base transmitter module, for example a time stamp from a time base unit, and stores it in a memory, preferably in a first register of the logic module.

The subsequent steps 303 and 304 correspond largely to steps 301 and 302. Again, the logic module reads the constantly provided data item at the stipulated address of the routing unit by means of obstructive reading (step 303), and an associated base value (for example a time stamp from a time base module) is stored in a further memory, preferably in a second register of the logic module.

In this exemplary embodiment, the difference between the two stored base values is formed in step 305, and the difference value is again stored in a memory, preferably in a third register of the logic module.

In the subsequent steps, these stored time base values are compared with previously stipulated comparison values. In this case, by way of example, the comparison can be made with maximum and/or minimum values, for example also including permitted value tolerances. In particular, access to the registers in the logic module which is used to store the comparison values also allows the comparison values to be configured or altered by the logic module and/or the external CPU (computation unit) depending on the application or on the basis of the value of particular parameters.

In this case, step 306 corresponds to a check to determine whether the difference between the time base values in the third register is greater than zero or is greater than a minimum value, and step 307 corresponds to a check to determine whether the difference is below a prescribed limit.

Step 308 then records whether all comparisons are successful or whether at least one was unsuccessful. In the case of one or more unsuccessful comparisons, consequences, such as error messages, computation unit interrupts (CPU interrupts) or messages to other modules (e.g. monitor module 107), are accepted for the unsuccessful comparison/the unsuccessful comparisons in step 309. By way of example, the consequences may also be dependent on which comparison and in what way the comparison was unsuccessful. From this step 310, the method advances to step 311. If all comparisons have progressed successfully, the method can skips to step 310. From this step, it is a simple matter to advance to step 311, but it is also possible to send messages about the successful comparison or else simply about the fact that a comparison/comparisons has/have actually been performed, for example to other modules, such as the monitor module 107, or else to the external CPU, for example, by an interrupt. In this case too, the method advances to step 311.

This step 311 corresponds to the conclusion of the method. If appropriate, it again skips to the start of the method, step 301.

An alternative embodiment can also be used for a routing principle according to which all data sources are arbitrated in succession. In the method described for FIG. 3, or correspondingly in the further exemplary embodiments, this requires the obstructive reading to be effected by means of obstructive writing to an address (data sink) which is configured such that it is always ready to accept a data item. In this case, the multichannel sequencer, as a data source, reports (always using the same channel, that is to say the same data source, when the physical unit multichannel sequencer 109 or 200 corresponds logically to a plurality of data sources associated with the routing unit 101) a write request to the routing unit 101. In a similar manner to the above approach, the successful writing of the data item by the multichannel sequencer 109 to the particular data sink of the routing unit 101 then triggers the reception of an assigned base value by the base transmitter module (e.g. module 103). An appropriate second write operation allows a second base value to be obtained and the further procedure from that time onward to be as in the exemplary embodiments for the sequential arbitration of the sources, that is to say that, by way of example, the difference between the base values can be formed, this difference can be compared with comparison values, and measures can be initiated if appropriate.

In general, the checking or monitoring of a cycle duration for a routing unit is thus effected by obstructive access by the logic unit to a particular address or a particular data node in the routing unit of assigned data nodes. In this case, the logic unit (that is to say the physical unit) is (logically) itself at least one data sink and at least one data source. It belongs to a group of data nodes associated with the routing unit, which data nodes the routing unit arbitrates successively on the basis of a stipulated or stipulatable order. The cycle duration of the routing unit is therefore determined by the complete passage through this arbitration order. Such a group of data nodes can comprise just data sinks, just data sources or a mixture, for example. The access to the particular address is then effected as write access, for example, if the particular data node is a data sink, the logic unit is a data source and the data sources are arbitrated successively in a stipulated order. The access to the particular address is effected as read access, for example, if the particular data node is a data source, the logic unit is a data sink and the data sinks are arbitrated successively in a stipulated order.

1. A hardware data processing unit comprising:
at least one base transmitter module configured to provide base values for a physical variable;
at least one logic unit;
at least one routing unit configured to arbitrate a group of data nodes associated with the base values successively in a stipulated order, wherein the at least one logic unit belongs to the group of data nodes and wherein a complete passage through the stipulated order determines a cycle duration; and
a mechanism via which the logic unit is configured to check the cycle duration of the routing unit by:
effecting a first obstructive access to a particular data node, wherein the particular data node is constantly ready for the access;
receiving and storing a first base value for the physical variable from the base transmitter module when triggered by the first access;
effecting a second obstructive access to the particular data node;
receiving and storing a second base value for the physical variable from the base transmitter module when triggered by the second access; and
forming a difference between the first and second base values.

2. The hardware data processing unit as claimed in claim 1, wherein the group of associated data nodes are data sinks and the first and second obstructive access operations are read access operations.

3. The hardware data processing unit as claimed in claim 1, wherein the group of associated data nodes are data sources and the first and second obstructive access operations are write access operations.

4. The hardware data processing unit as claimed in claim 1, further comprising a mechanism configured to provide time stamps as base values for the a physical variable ‘time’.

5. The hardware data processing unit as claimed in claim 1, further comprising a mechanism configured to provide angle stamps as base values for the a physical variable ‘angle’.

6. The hardware data processing unit as claimed in claim 1, further comprising a mechanism configured to compare the difference in the base values with at least one comparison value.

7. The hardware data processing unit as claimed in claim 6, further comprising a mechanism configured to generate an error signal and/or to prompt a computation unit interrupt when an unsuccessful comparison occurs.

8. The hardware data processing unit as claimed in claim 6, further comprising a mechanism configured to generate an activity signal when the comparison is performed.

9. A method for checking a cycle duration of a routing unit in a hardware data processing unit comprising:
arbitrating, with the routing unit, data sources associated with a base for a physical variable successively in a stipulated order, wherein a logic unit in the hardware data processing unit belongs to the successively arbitrated data sources;
determining the cycle duration from a complete passage through the stipulated order, wherein the hardware data processing unit has at least one base transmitter module configured to provide base values for the physical variable by:
effecting a first obstructive writing to a particular data sink in the routing unit via the logic unit, wherein the particular data sink in the routing unit is constantly able to read a data item;
receiving and storing a first base value for the physical variable from the base transmitter module via the logic unit when triggered by the first obstructive writing of the data item;
effecting a second obstructive writing to the particular data sink in the routing unit via the logic unit;
receiving and storing a second base value for the physical variable from the base transmitter module via the logic unit when triggered by the second obstructive writing; and
forming a difference between the first and second base values.

10. A method for checking a cycle duration of a routing unit in a hardware data processing unit comprising:
arbitrating, with the routing unit, data sinks associated with a base for a physical variable successively in a stipulated order, wherein a logic unit in the hardware data processing unit belongs to the successively arbitrated data sinks;
determining the cycle duration by from a complete passage through the stipulated order, wherein the hardware data processing unit has at least one base transmitter module configured to provide base values for the physical variable by:
effecting a first obstructive reading from a particular data source in the routing unit via the logic unit, wherein the particular data source in the routing unit constantly has a data item available;
receiving and storing a first base value for the physical variable from the base transmitter module via the logic unit when triggered by the first obstructive reading of the data item;
effecting a second obstructive reading from the particular data source in the routing unit via the logic unit;
receiving and storing a second base value for the physical variable from the base transmitter module via the logic unit when triggered by the second obstructive reading; and
forming a difference between the first and second base values via the logic unit.

11. The method as claimed in claim 9, wherein the physical variable is a time and the base values are implemented as time stamps.

12. The method as claimed in claim 9, wherein the physical variable is an angle and the base values are implemented as angle stamps.

13. The method as claimed in claim 9, wherein at least one comparison is made between the difference and comparison values.

14. The method as claimed in claim 13, wherein an error signal is generated and/or a computation unit interrupt is prompted when the at least one comparison is unsuccessful.

15. The method as claimed in claim 13, wherein an activity signal is generated when the at least one comparison is performed.

16. The method as claimed in claim 10, wherein the physical variable is a time and the base values are implemented as time stamps.

17. The method as claimed in claim 10, wherein the physical variable is an angle and the base values are implemented as angle stamps.

18. The method as claimed in claim 10, wherein at least one comparison is made between the difference and comparison values.

19. The method as claimed in claim 18, wherein an error signal is generated and/or a computation unit interrupt is prompted when the at least one comparison is unsuccessful.

20. The method as claimed in claim 18, wherein an activity signal is generated when the at least one comparison is performed.
